(19) United States
(12) Patent Application Publication
(10) Pub. No.: US 2024/0106156 A1
(43) Pub. Date: Mar. 28, 2024

(54) Electric Connector Unit

(71) Applicant: Tyco Electronics Japan G.K., Kawasaki-shi (JP)

(72) Inventor: Zhonghuan Shen, Kawasaki-shi (JP)

(73) Assignee: Tyco Electronics Japan G.K., Kawasaki-shi (JP)

(21) Appl. No.: 18/535,294

(22) Filed: Dec. 11, 2023

Related U.S. Application Data
(63) Continuation of application No. PCT/JP2022/022973, filed on Jun. 7, 2022.

(30) Foreign Application Priority Data
Jun. 11, 2021 (JP) 2021-098150

(51) Int. Cl. H01R 13/514; H02G 3/16

(52) U.S. Cl. CPC H01R 13/514; H02G 3/16

(57) ABSTRACT

A electrical connector unit is equipped with a connector to which a cable is to be connected, the connector has an outer housing and an inner housing provided in the outer housing, the inner housing is an inner housing having a first sub housing and a second sub housing that are mutually connected via a bridge element, and the inner housing is directly engageable with the outer housing.

### CROSS-REFERENCES TO RELATED APPLICATIONS

This application claims priority to Japanese Patent Application No. 2021-098150 filed on Jun. 11, 2021 and to PCT Application WO PCT/JP2022/022973 filed on Jun. 7, 2022.

### FIELD OF THE INVENTION

The present disclosure relates to electrical connectors. In particular, the present disclosure relates to electrical connector units for connecting a cable.

### BACKGROUND

Electrical connector units are equipped with a connector to which a cable is to be connected. Conventional connectors have a power supply terminal inner housing for supporting the power supply terminal and a signal terminal inner housing for supporting the signal terminal, which are housed in an outer housing and coupled to a coupling element. In these connectors, a power supply terminal inner housing and a signal terminal inner housing are generally assembled by a coupling element such as a frame body to be housed in the outer housing.

When using a coupling element, it is necessary to pre assemble a plurality of parts such as a power supply terminal inner housing, a signal terminal inner housing, a coupling element, and the like in advance and then attach the subassembly to the outer housing of the connector. In other words, it is necessary to prepare the subassembly composed of the above plurality of parts before attaching it to the outer housing. This will lead to a relatively large number of parts composing the connector, resulting in a risk of a low assembly efficiency of the connector.

It is an object of the present disclosure, among other objects to provide an electrical connector unit equipped with a connector capable of improving assembly efficiency.

### SUMMARY

The present disclosure provides an electrical connector unit equipped with a connector to which a cable may be connected, wherein the connector has an outer housing and an inner housing provided in the outer housing. The inner housing has a first sub housing and a second sub housing that are connected to each other by a bridge element. The inner housing is directly engageable with the outer housing.

### BRIEF DESCRIPTION OF DRAWINGS

The invention will now be described with reference to the accompanying figures of which:

FIG. 1 is an isometric view showing an electrical connector unit according to one embodiment of the present disclosure;

FIG. 2 is an exploded isometric view showing an electrical connector unit according to one embodiment of the present disclosure;

FIG. 3 is an isometric view showing an outer housing;

FIG. 4 is an isometric view showing an inner housing;

FIG. 5 is a top view showing an inner housing viewed from the device connector side;

FIG. 6 is a top view showing a device with an outer housing and an inner housing, viewed from the device connector side;

FIG. 7 is a top view showing a device connector viewed from the connector side; and

FIG. 8 is an isometric view showing an electrical connector unit according to another embodiment of the present disclosure.

### DETAILED DESCRIPTION OF EMBODIMENTS

The following describes an electrical connector unit of the present disclosure with reference to the drawings. Various elements in the drawings are only shown schematically and exemplarily for the purpose of illustrating the present disclosure, and the appearance, dimensional ratio, or the like may differ from the actual product.

Furthermore, in the following description, terms are used to indicate specific directions and locations where necessary. However, the use of those terms is to facilitate understanding of the invention through the drawings, and the technical scope of the present disclosure is not limited by the meanings of those terms. In addition, parts with the same symbol in a plurality of drawings refer to the same or equivalent parts.

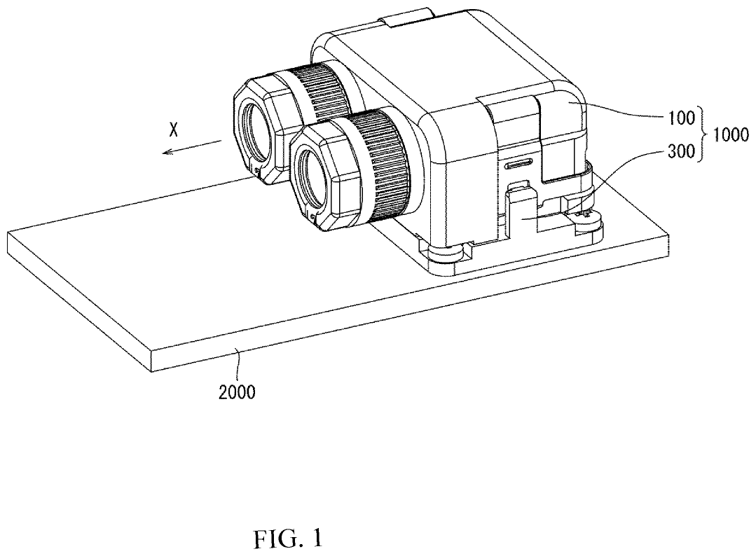

As shown in FIG. 1, an electrical connector unit 1000 of the present disclosure is electrically connectable to a predetermined device 2000, for example, a motor used in industrial machinery or industrial robots. The electrical connector unit 1000 has a connector 100 and a device connector 300. The connector 100 is connectable to a cable. The device connector 300 is located in the device 2000.

A “unit” as used in this description refers to an assembly composed of a plurality of components. Thus, the electrical connector unit 1000 of the present disclosure is an assembly with at least the connector 100 to which a cable is to be connected and the device connector 300 that is assembled with the connector 100.

The electrical connector unit 1000 is used to establish two or more electrical circuits between a cable and the device 2000. As one example, between a cable and the motor or the like, it is used to establish (1) an electrical circuit for supplying to the motor a power supply voltage used to drive or brake the motor, and (2) an electrical circuit for transmitting signals from a sensor (equivalent to an encoder) that detects information on rotation of the device and/or to a component (equivalent to a brake) for stopping the operation of the motor.

As described above, an exemplary first internal cable supplies power to a motor. An exemplary second internal cable passes signals that are output from an encoder. An exemplary third internal cable passes signals that are sent to the brake. There can be a plurality of cables for each of the first internal cable, the second internal cable, and the third internal cable. Each of the internal cables has a conductor, such as a pure copper wire or tinned copper wire, and an insulating internal cable coating surrounding the outer circumference of the conductor. At the end portion of the internal cables, a terminal is housed in the inner housing of the connector 100, which is described below.

In one example, a single composite cable having the above-described first and second internal cables inside as a whole may be used. Optionally, a single composite cable may further have the third internal cable inside. In the case of a single composite cable, the outer surface of the composite cable itself having these internal cables inside may be composed of a conductive cable shield and an insulating jacket surrounding the conductive cable shield. In addition, a plurality of internal cables of the same type are bundled together, while the first and second internal cables of different types are further separated by a cable shield and an insulating jacket surrounding the conductive cable shield.

In another example, two or more cables may be used. In this case, for example, the first cable has a first internal cable bundle composed of a plurality of first internal cables that are for power supply and of the same type, a shield surrounding the first internal cable bundle, and an insulating jacket surrounding the cable shield.

Optionally, the first cable can have a third internal cable inside that is for signals that are sent to the brake. In this case, the first cable further has a third internal cable bundle composed of a plurality of third internal cables of the same type, a cable shield surrounding the third internal cable bundle, and an insulating jacket surrounding the cable shield. A plurality of first internal cables of the same type are bundled into one, while a first internal cable and a third internal cable that are of a different type are further separated by a cable shield and an insulating jacket surrounding the cable shield.

In addition, the second cable has a second internal cable bundle composed of a second internal cable for signals that are output from the encoder, a cable shield surrounding the second internal cable bundle, and an insulating jacket surrounding the cable shield.

When connecting a cable to the connector 100, terminal processing for the cable is performed by removing the end portion of the insulating jacket covering the outer circumference of the cable shield surrounding each internal cable bundle, folding the cable shield end portion entirely outward, and wrapping copper tape around the folded portion. By crimping the cable shield with the copper tape, they are electrically connected, thereby making an electromagnetic shield.

The cable shield described above is a conductive material so as to electrically shield the internal cable bundle. Preferably, the cable shield is a braid formed from a plurality of conductive strands or fibers or other conductive stranded wires for durability and flexibility. The braid used for the cable shield, which is not limited in particular, may be made of a highly conductive material such as copper, copper alloys, aluminum, or aluminum alloys. Also, the surface of the material may be coated with a conductive plating layer such as tin plating, nickel plating, or silver plating to prevent oxidation and rust development.

The insulating jacket surrounding the above cable shield may be formed from polyvinyl chloride (PVC), polypropylene, fluoropolymers, polyethylene and/or the same kind of polymers, among others.

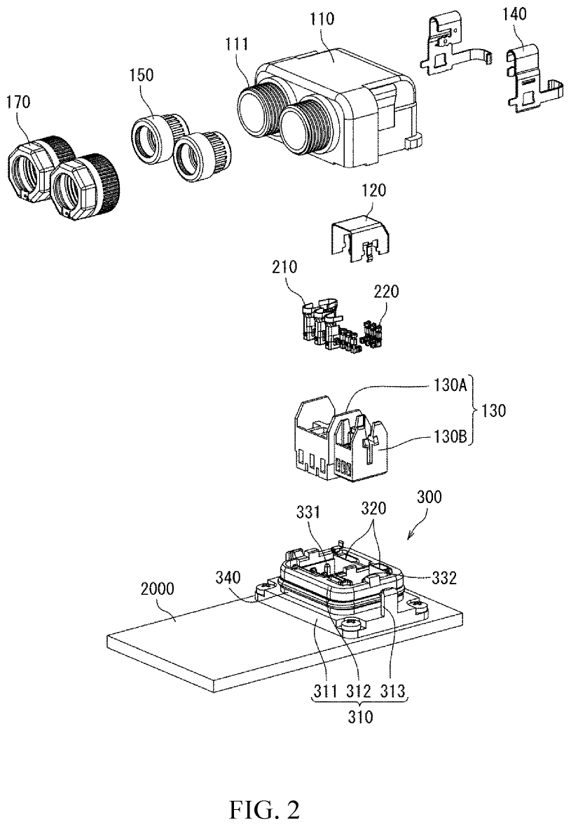

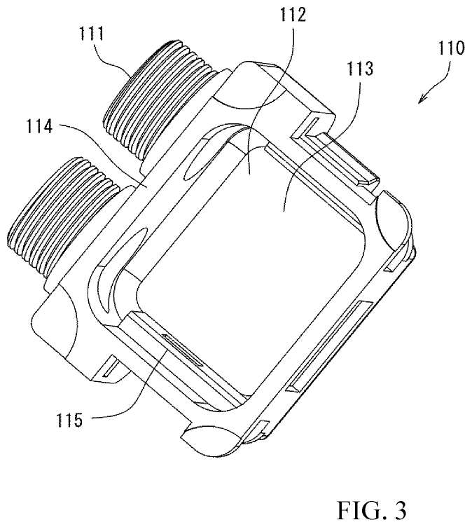

As shown in FIG. 2, the connector 100 has an outer housing 110 and an inner housing 130 positioned inside the outer housing 110. As shown in FIG. 3, the outer housing 110 is an insulating element and has a recess 113 having an internal housing receiving area 112 on the side opposed to the device connector 300. The recess 113 is a space defined by a plurality of sidewalls 114 that are mutually continuous and a bottom.

If one composite cable is used as the cable described above, one insertion opening 111 may be disposed in the outer housing 110. On the other hand, if two or more cables are used, two or more insertion openings 111 may be disposed in the outer housing 110. In one example, as shown in FIGS. 1 to 3, two insertion openings 111 receive the cables extending outwardly through each insertion opening 111. The insertion openings 111 have a cylindrical shape extending outside of the outer housing 110. Also, as shown in FIG. 2, a cap 170 is provided. It is threaded around the insertion opening 111 to secure the cable in the insertion opening 111 and to seal it. An annular seal 150 is located between the cap 170 and the insertion opening 111 for sealing.

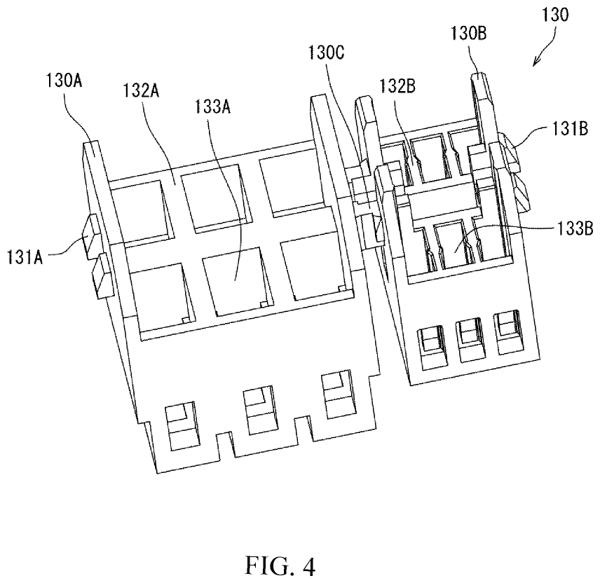

As shown in FIG. 4, the inner housing 130 has a first sub housing 130A and a second sub housing 130B. A “sub housing” as used in this description refers to a component of an inner housing. The inner housing 130 houses a first connector-side terminal 210 (see FIG. 2) connected to the end portion of the first internal cable described above and a second connector-side terminal 220 (see FIG. 2) connected to the end portion of the second internal cable.

The first sub housing 130A has a plurality of lattice-shaped internal spaces 133A separated by a partition wall 132A. The first connector-side terminal 210, for example, a power supply terminal connected to the end portion of the first internal cable is located in the internal space 133A Similarly, the second sub housing 130B has a plurality of lattice-shaped internal spaces 133B separated by a partition wall 132B. The second connector-side terminal 220, for example, a signal terminal, connected to the end portion of the second internal cable is located in the internal space 133B. In one example, the number of first connector-side terminals 210 and the number of second connector-side terminals 220 described above may be the same. In another example, the number of first connector-side terminals 210 and the number of second connector-side terminals 220 described above may be different.

The outer housing 110 and inner housing 130 described above are formed of an insulating material. Insulating materials can include, but are not limited to in particular, for example, at least one kind of thermosetting resin selected from the group consisting of epoxy resin, phenolic resin, silicone resin, and unsaturated polyester resin.

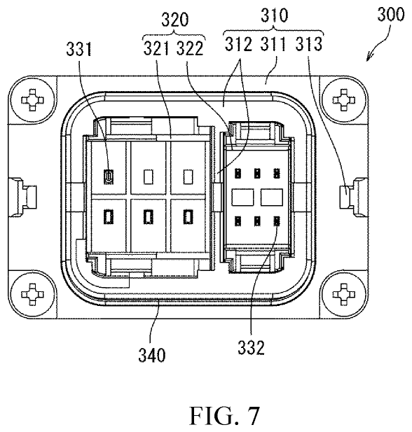

As shown in FIGS. 2 and 7, the device connector 300 has a conductive device housing 310, two or more insulating device housings 320 positioned spaced apart in the conductive device housing 310, a device-side terminal supported in each insulating device housing 320, and a device seal 340.

The conductive device housing 310 has a base 311, a frame 312, and a protrusion 313. The base 311 is electrically connected to the main surface of the device 2000 so as to be groundable. The frame 312 is configured to extend from the base 311 to the installation side of the connector 100.

Specifically, the frame 312 is configured to surround the two insulating device housings 320 spaced from each other and partition between these insulating device housings 320. Such a configuration enables electromagnetic shielding to the outside and electromagnetic shielding between the first device-side terminal and the second device-side terminal supported in the insulating device housing 320, which will be described below. The protrusion 313 has a catch engageable by a locking clip 140 for connecting the outer housing 110 and the device connector 300.

Although not specifically limited, the conductive device housing 310 may be formed, for example, from a metal, such as aluminum or an aluminum alloy, or a resin with conductive plating on its surface. For ease of productivity and dimensional accuracy, the conductive device housing 310 may be formed by die casting aluminum.

In the case where the two insulating device housings 320 are positioned in the conductive device housing 310 as an example, the first insulating device housing 321 can be positioned so as to be opposite to the first sub housing 130A when the connector 100 and the device connector 300 are assembled. Further, the second insulating device housing 322 can be positioned so as to be opposite to the second sub housing 130B.

The first insulating device housing 321 and the second insulating device housing 322 are positioned spaced apart from each other by the frame 312 forming a partition part. A first device-side terminal 331 is supported in the first insulating device housing 321. If the first device-side terminal 331 is, for example, a power supply terminal, the first device-side terminal 331 may be connectable to a motor. A second device-side terminal 332 is supported in the second insulating device housing 322. If the second device-side terminal 332 is, for example, a signal terminal, the second device-side terminal 332 may be connectable to a sensor or the like.

The number of first device-side terminals 331 in the first insulating device housing 321 corresponds to the number of first connector-side terminals 210 described above. Similarly, the number of second device-side terminals 332 in the second insulating device housing 322 corresponds to the number of second connector-side terminals 220 described above. Accordingly, as an example, if the number of first connector-side terminals 210 and the number of second connector-side terminals 220 are the same as described above, then correspondingly, the number of first device-side terminals 331 and the number of second device-side terminals 332 are the same. On the other hand, as another example, if the number of first connector-side terminals 210 and the number of second connector-side terminals 220 are different as described above, then correspondingly, the number of first device-side terminals 331 and the number of second device-side terminals 332 are also different.

By adopting this configuration, when the connector 100 is assembled with the device connector 300, the first connector-side terminal 210 and the first device-side terminal 331 are in contact with each other, and the second connector-side terminal 220 and the second device-side terminal 332 are in contact with each other. Such contact enables electrical connection between the device 2000 and the cables.

The insulating device housing 320 described is formed from an insulating material in the same way as the outer housing 110 and inner housing 130 described above. Insulating materials can include, but are not limited to in particular, for example, at least one kind of thermosetting resin selected from the group consisting of epoxy resin, phenolic resin, silicone resin, and unsaturated polyester resin.

The device seal 340 is also provided to prevent water from entering.

between the connector 100 and the device connector 300. The device seal 340 is positioned on the outer periphery of the frame 312. Further, the device seal 340 can also be disposed at the connection between the base 311 and the device 2000 to prevent water from entering the internal from between the device connector 300 and the device 2000.

In an embodiment, the first sub housing 130A, the bridge element 130C, and the second sub housing 130B can be integral, so that, as a whole, the inner housing 130 can be formed as a single component. Therefore, the inner housing 130 formed as a single component can be directly assembled with the outer housing 110 without using a coupling element. This allows reducing the number of parts of the connector 100 relatively, compared to the conventional embodiments that use a coupling element. As a result, the present disclosure makes it possible to improve the assembly efficiency of the connector 100.

In the present disclosure, the shield 120, since it functions as a shielding element for the terminal connected to the distal end portion of the internal cable, may be mounted against the top surface of the inner housing 130, the second sub housing 130B, so as to cover the internal cable extending from the end portion of the cable 200 and the terminal from above. It can be mounted against the top surface. Although not particularly limited, the shield 120 can be formed, for example, by punching and/or bending a conductive soft metal thin plate.

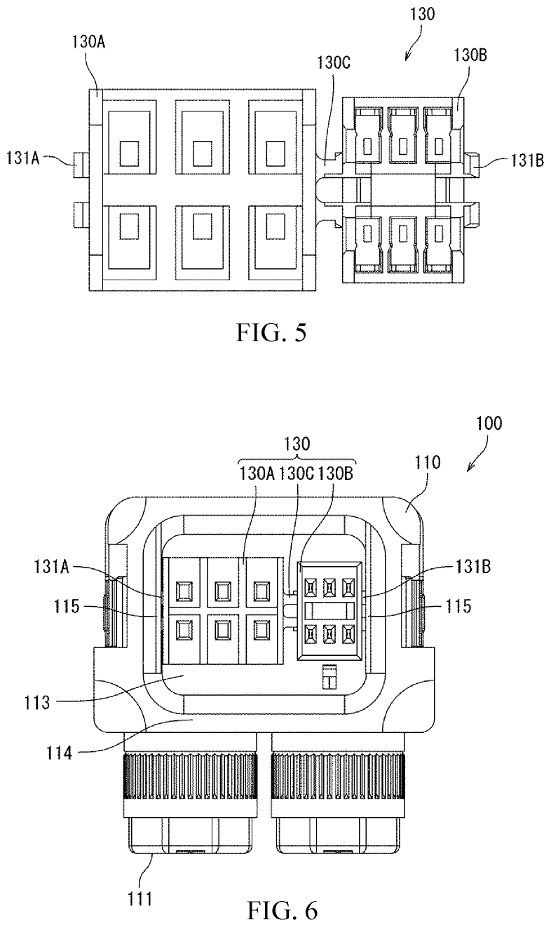

The above-described direct assembly of the inner housing 130 with the outer housing 110 can be achieved by the following embodiment. Specifically, as shown in FIG. 4 and FIG. 5, the inner housing 130 is configured so as to be provided with a first protrusion 131A on one side and a second protrusion 131B on the other side opposed to each other. The first protrusion 131A and the second protrusion 131B are positioned so as to be opposed to each other. Preferably, in a plan view, the first protrusion 131A and the second protrusion 131B can be positioned along a line or in symmetry.

As shown in FIG. 3, the outer housing 110 also has two recessed shoulders 115 formed in the sidewall 114. One of the two recessed shoulders 115 is configured to engage with the first protrusion 131A of the inner housing 130 described above. The other of the two recessed shoulders 115 is configured to engage with the second protrusion 131B of the inner housing 130 described above.

The outer housing 110 has opposing protrusions, while the inner housing 130 has mutually opposed recessed shoulders with which each of these protrusions engage. As shown in FIG. 6, when installing the inner housing 130 in the outer housing 110, the two mutually opposed recessed shoulders 115 of the outer housing 110 and the two mutually opposed protrusions 131A and 131B of the inner housing 130 engage with each other. This allows providing two points of direct engagement between the outer housing 110 and the inner housing 130. Specifically, in a plan view, the two direct engagement points can be formed on one side and the other side of the inner housing 130. As a whole, this makes possible the stable mounting arrangement of the inner housing 130 to the outer housing 110 without using a coupling element or frame body.

With the first protrusion 131A and the second protrusion 131B of the inner housing 130 are positioned in a line or point symmetry and the two recessed shoulders 115 of the outer housing 110 are also positioned in line or point symmetry, the two engagement points formed by the engagement of these protrusions and recessed shoulders will also be positioned in line or point symmetry. There may be more than one set of two engagement points formed on one side and the other side of the inner housing 130. As the number of such sets increases, a more stable mounting arrangement of the inner housing 130 to the outer housing 110 is achieved. In one example, as shown in FIG. 6, both of the two sets of engagement points may be positioned on the two mutually opposed sidewalls 114 of the outer housing 110. In another example, one of the two sets of engagement points may be positioned on the two mutually opposed sidewalls 114 of the outer housing 110 and the other of the two sets of engagement points may be positioned on the other two mutually opposed sides of the outer housing 110.

If these two engagement points are positioned in line or point symmetry, as previously described, assuming that the first sub housing 130A and the first insulating device housing 321 are positioned opposite to each other and the second sub housing 130B and the second insulating device housing 322 are positioned opposite to each other, the inner housing 130 is suitably engaged with the outer housing 110 that has been rotated from its predetermined position in a plan view. This allows the inner housing 130 to be installed even inside the rotated outer housing 110.

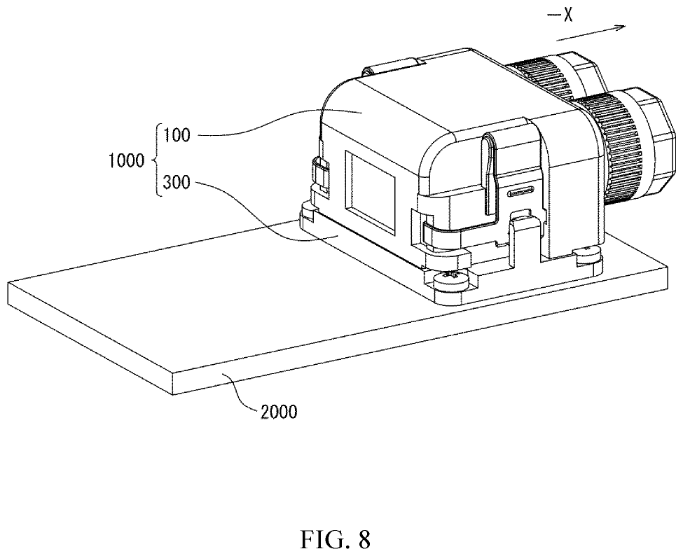

In one example, as shown in FIG. 1, an electrical connector unit outer housing 110 is assembled to the device connector 300 with a cable extending in the X direction. As shown in FIG. 8, an electrical connector unit outer housing 110 is assembled to the device connector 300 with a cable extending in the opposite minus X direction. In addition to this, an electrical connector unit having the connector 100 and the device connector 300 assembled such that cables extend in the Z direction, corresponding to the height direction, is also possible.

From the above, if the two engagement points are positioned in line or point symmetry, outer housings 110 may each have a cable extending out in different directions from each other. It is thereby possible to increase the degree of freedom in the arrangement of a power supply and a signal transmitting and receiving device that are connected to the cable.

In particular, with the two engagement points positioned in line or point symmetry, by using outer housings 110 having the same shape and size, it is possible to assemble the inner housing 130 in the outer housing 110 in predetermined or rotated orientations.

In assembling the connector 100 with the device connector 300, even if positioning is “incorrectly” performed in such a way that the first sub housing 130A and the second insulating device housing 322 are opposite to each other while the second sub housing 130B and the first insulating device housing 321 are opposite to each other, there are advantages in the following respects. Specifically, for example, a projected part in the first sub housing 130A can abut the main surface of the second insulating device housing 322 where no recessed shoulder is formed. In another example, a projected part provided in the second sub housing 130B can abut the main surface of the first insulating device housing 321 where no recessed shoulder is formed. This allows suitable avoidance of contact between the first connector-side terminal 210 and the second device-side terminal 332, and between the second connector-side terminal 220 and the first device-side terminal 331. That is, in the electrical connector unit of the present disclosure, preventing incorrect insertion of terminals, by “keying,” can be suitably performed. As a result, electrical connection failures between the device 2000 and the cable can be prevented.

The electrical connector unit of the present disclosure has been described above; however, the present disclosure is not limited to the above, and various changes, such as combining the above configurations, are possible based on the knowledge of those skilled in the art, so long as such changes do not deviate from the intent of the claims.

What is claimed is:

1. An electrical connector unit for a cable comprising:
an outer housing;
an inner housing located in the outer housing, the inner housing having a first sub housing and a second sub housing that are connected to each other via a bridge element, the inner housing being directly engageable with the outer housing.

2. The electrical connector unit as set forth in claim 1, wherein the first sub housing, the bridge element, and the second sub housing are continuous, such that the inner housing forms an integral component.

3. The electrical connector unit as set forth in claim 1, wherein one of the outer housing and the inner housing has opposed protrusions, and the other of the outer housing and the inner housing has mutually opposed recessed shoulders with which each of the protrusions engage.

4. The electrical connector unit as set forth in claim 3, wherein two engagement points of the inner housing engage the outer housing.

5. The electrical connector unit as set forth in claim 4, wherein the two engagement points are positioned in line symmetry or point symmetry.

6. The electrical connector unit as set forth in claim 1, further comprising a device connector assembled with the connector, wherein the device connector has a conductive device housing, a first insulating device housing positioned in the conductive device housing opposite to the first sub housing, and a second insulating device housing positioned opposite to the second sub housing.

7. The electrical connector unit as set forth in claim 6, wherein, the inner housing is adapted to be assembled to the outer housing in predetermined and rotated positions.

8. The electrical connector unit as set forth in claim 7, wherein the outer housing may be oriented in predetermined and rotated positions.

9. The electrical connector unit as set forth in claim 8, wherein a plane size of the first sub housing and a plane size of the second sub housing are different from each other.

10. The electrical connector unit as set forth in claim 6, wherein, a protrusion provided on one of the sub housing and the insulating device housing and a recessed shoulder provided on the other thereof are matable in either the first sub housing and the first insulating device housing or the second sub housing and the second insulating device housing.

11. The electrical connector unit as set forth in claim 10, wherein the protrusion and the recessed shoulder are located opposite to each other to form a keying arrangement for assembly.

12. The electrical connector unit as set forth in claim 1, wherein the cable is a single composite cable having at least a first internal cable and a second internal cable.
